(19) United States
(12) Patent Application Publication
(10) Pub. No.: US 2015/0314332 A1
(43) Pub. Date: Nov. 5, 2015

(54) SORTING MINED MATERIAL

(71) Applicant: TECHNOLOGICAL RESOURCES PTY. LIMITED, Brisbane, Queensland (AU)

(72) Inventors: Georgios DIMITRAKIS, Nottingham (GB); Samuel KINGMAN, Burton On Trent (GB); Christopher DODDS, Nottingham (GB); Juliano KATRIB, Nottingham (GB); Andrew BATCHELOR, Nottingham (GB); Aled JONES, Nottingham (GB)

(21) Appl. No.: 14/648,483

(22) PCT Filed: Nov. 29, 2013
(86) PCT No.: PCT/AU2013/001390

§ 371 Date: May 29, 2015

(30) Foreign Application Priority Data
Nov. 30, 2012 (AU) 2012905281

(51) Int. Cl. B07C 5/34; G01J 5/10; B07C 5/02

(52) U.S. Cl. CPC B07C 5/34; B07C 5/02; G01J 5/10; G01J 2005/0077

(57) ABSTRACT

A method of sorting fragments of mined material that includes valuable and non-valuable materials is disclosed. The method comprising heating the fragments by heating selected materials within the fragments and thermally analysing fragments of the mined material to determine the temperature of each fragment. The method further comprises sorting fragments on the basis of the thermal analysis to separate fragments having a temperature within a temperature band defined by a range between an upper temperature limit and a lower temperature limit from fragments having a temperature outside the temperature band. The upper and lower temperature limits are selected to identify fragments as containing an amount of valuable material that is economically viable to extract based on the fragment temperature. Also disclosed are an apparatus for sorting mined material and a method of recovering valuable material by sorting in according with the sorting method.

### TECHNICAL FIELD

The present invention relates to a method and an apparatus for sorting mined material.

The present invention relates particularly, although by no means exclusively, to a method and an apparatus for sorting mined material for subsequent processing to recover valuable material, such as valuable metals, from the mined material.

The term “mined” material is understood herein to include, but is not limited to, (a) run-of-mine material and (b) run-of-mine material that has been subjected to at least primary crushing or similar size reduction after the material has been mined and prior to being sorted. The mined material includes mined material that is in stockpiles.

The present invention also relates to a method for recovering valuable material, such as valuable metals, from a mined material that has been sorted as described above.

In general terms, the present invention relates to sorting criteria applied in the methods and apparatus described above for identifying mined material from which valuable material can be recovered.

A particular, although not exclusive, area of interest to the applicant is mined material in the form of mined ores that include copper-containing materials, such as chalcopyrite, in sulphide forms.

### BACKGROUND

The applicant is developing an automated sorting method and apparatus for mined material.

In general terms, the method of sorting mined material being developed by the applicant includes the following steps:
(a) exposing particles of mined material to electromagnetic radiation,
(b) detecting and assessing particles on the basis of composition (including grade) or texture or another characteristic of the particles based on their thermal profile induced by the exposure to the electromagnetic radiation, and
(c) physically separating particles based on the assessment in step (b).

One challenge in implementing an automated sorting method and apparatus successfully is the accuracy of the sorting. In other words, considerable effort is being put into ensuring that mined material is appropriately classified according to sorting criteria and is physically separated based on the sorting criteria so that product streams leaving the sorting apparatus have the properties required for the designated downstream processing. For example, it would be uneconomic to operate a smelting plant or a flotation plant where a feed stream of mined material from the sorting apparatus contains less of a valuable material than is required to run the plant economically.

The required content of valuable material in mined material will vary depending on the type of mined material. For low grade sulphide copper ores, for example, mined material containing less than 0.6 wt % copper is economic to process provided fragments of copper ore can be separated from fragments of ore that are relatively barren of copper, i.e. contain no copper or only a very small amounts. Given the relatively low content of valuable material, the economics of recovery processes (including the sorting process) rely on being able to process large quantities of mined material. The accuracy of the sorting process, therefore, is important to the economics of the entire mining and recovery operation.

The term “barren” fragments when used in the context of copper-containing ores are understood herein to mean fragments with no copper or very small amounts of copper that cannot be recovered economically from the fragments.

The term “barren” fragments when used in a more general sense in the context of valuable materials is understood herein to mean fragments with no valuable material or amounts of valuable material that cannot be recovered economically from the fragments.

The above references to the background art do not constitute an admission that the art forms a part of the common general knowledge of a person of ordinary skill in the art. The above references are also not intended to limit the application of the apparatus and method as disclosed herein.

### SUMMARY OF THE DISCLOSURE

The applicant has recognised that selecting electromagnetic radiation of an appropriate frequency for which the valuable material in mined material has strong susceptibility causes heating of mined material such that thermal analysis of fragments of mined material can be utilised to distinguish fragments that contain valuable material from fragments that contain very little or no valuable material. Accordingly, applying a threshold minimum heating of fragments as a sorting criterion enables the mined material to be separated in economic and non-economic product streams. In other words, the mined material is sorted on the basis that fragments that are heated to a temperature more than a cut-off temperature, i.e. “hot” fragments, contain valuable material and fragments heated to less than the cut-off temperature, i.e. “cold” fragments, contain very little or no valuable material.

The applicant recognises, however, that the temperature of the “hot” fragments is not always indicative of the content of valuable material in the mined material. In particular, the applicant recognises that mineralogically complex ores may contain some barren minerals that are as susceptible or more susceptible to the electromagnetic radiation as the valuable material. This often causes fragments containing these barren minerals to “super heat”, i.e. rise in temperature more than fragments containing the valuable material.

The applicant has also found that some mined material includes clay and/or other material, e.g. magnetite, iron sulphides and biotote (FE-bearing gangue), that is susceptible to electromagnetic radiation and which is barren of valuable material, but has a water content that makes it susceptible to some electromagnetic radiation. The clay is found on the surface of fragments and is found within the structure of fragments so that, in a sorting method as described above, the fragments appear as “hot” fragments. The clay can, therefore, return a false positive based on the sorting criterion that requires a threshold minimum fragment heating. Accordingly, sorted “hot” fragments may comprise a mixture of barren fragments and fragments that contain valuable material. The term “clay” is a reference to a range of minerals that form clay.

This means that sorting processes that involve exposing fragments to electromagnetic radiation and sorting on the basis of fragment temperature needs an upper cut-off temperature for separating hot barren fragments from hot fragments that include valuable material.

Accordingly, one aspect of the present invention provides a method of sorting fragments of mined material that includes valuable and non-valuable materials, with some fragments containing more valuable material or more non-valuable than other fragments, the method comprising:
(a) heating the fragments by heating selected materials within the fragments;
(b) thermally analysing fragments of the mined material to determine the temperature of each fragment; and
(c) sorting fragments on the basis of the thermal analysis to separate fragments having a temperature within a temperature band defined by a range between an upper temperature limit and a lower temperature limit from fragments having a temperature outside the temperature band; and
   wherein the upper and lower temperature limits are selected to identify fragments as containing an amount of valuable material that is economically viable to extract based on the fragment temperature caused by the heating.

Sorting fragments according to this method enables the fragments containing an amount of valuable material that is economically viable to extract sent to downstream processing steps to extract the valuable material and enables the barren material to be rejected as waste material, i.e. excluded from downstream processing steps. The method applies the general rule that hotter fragments are higher in valuable material grade than colder fragments and, at the same time, distinguishes between hot fragments that are suitable for downstream processing due to the valuable material content and hot barren fragments that would otherwise have been identified as suitable for downstream processing.

The upper temperature limit may be selected to discriminate between fragments that are heated by valuable materials and fragments that are heated by non-valuable materials that are more susceptible to heating than the valuable materials.

The combination of the clay being at surface of fragments and the clay having a water content that makes it susceptible to the electromagnetic radiation results in “hot” barren fragments being hotter than fragments containing valuable material. The same applies to mineralogically complex ores where include barren minerals, that are susceptible to electromagnetic radiation, are present. This means that fragments of mined material that contain the barren minerals can be distinguished on the basis of temperature from fragments containing the valuable materials. It also means that the extent to which barren fragments are mixed with fragments that contain valuable material can be reduced, thereby improving the economics of an overall process for recovering the valuable material from the mined material.

The method may further comprise physically separating the mined material into a stream containing fragments within the range between the upper and lower temperature limits and another stream of fragments that is outside the range.

The temperature band may be selected to identify fragments as containing valuable material based on a temperature or a temperature rise, caused by exposure to electromagnetic radiation, in the range and to identify fragments as barren fragments based on a temperature rise outside the range. The range may be a temperature rise 1 to 8° C. caused by the exposure to the electromagnetic radiation. The range may alternatively be a temperature rise 2 to 7° C. and may even be a temperature rise 3 to 6° C. caused by the exposure to the electromagnetic radiation. For fragments containing chalcopyrite as the valuable material in copper ore, the set range may be the latter.

The step of sorting the fragments may further comprise sorting the fragments within the temperature band into two or more streams.

The temperature band may be selected to sort the fragments containing valuable material into the two or more streams depending on suitability for a designated downstream processing option. The suitability may be determined by the content of valuable material within a fragment.

The step of heating the fragments may comprise exposing the fragments to electromagnetic radiation.

This embodiment takes advantage of the different susceptibilities of minerals within a fragment. The fragments are, therefore, heated by valuable or non-valuable materials that are susceptible to the electromagnetic radiation. Fragments that do not contain materials that are susceptible to electromagnetic radiation will not be heated. Additionally, fragments that contain only a small amount of susceptible materials will not be heated to the same extent as fragments that contain a greater amount of susceptible materials. Accordingly, fragments will be heated to different extents based on the quantity of susceptible materials and on the susceptibility of the materials. The thermal analysis and subsequent sorting, therefore, is able to identify and separate fragments for downstream processing from the remainder of the fragments.

The method may further comprise selecting the type, energy and frequency of the electromagnetic radiation and the length of exposure on the basis of facilitating a differential thermal response in the fragments of mined material to enable different temperatures of the fragments to be used as a basis for the thermal analysis.

The electromagnetic radiation may include X-ray, microwave and radio frequency radiation. Furthermore, step (a) may comprise exposing the fragments to pulsed or continuous electromagnetic radiation.

The method may further comprise allowing sufficient time for the heat generated in the fragments by exposure to the electromagnetic radiation to be transferred through the fragments so that the temperature on the surface of each fragment is a measure of the mass average temperature through the fragment.

The mined material may be a copper-containing ore and the valuable material is chalcopyrite and wherein step (a) may comprise exposing the mined material to microwave energy.

The step of heating the fragments may comprise exposing the fragments to an alternating magnetic field.

According to this embodiment, the fragments are heated by ohmic resistance to eddy currents induced in electrically conductive materials. This method for heating fragments is discussed in Australian provisional application 2013900972 and is incorporated herein by this reference. In this regard, the applicant recognises that an alternating magnetic field can indirectly induce electric fields in particles of mined material which in turn induce electric currents in the form of eddy currents in the electrically conductive materials in the particles, with the electric currents causing sufficient selective ohmic heating of the electrically conductive materials in particles in accordance with Joules First Law (i.e. the amount of heat (Q) produced in a specified time is the current squared (I²) multiplied by the electrical resistance (R) of the materials in the particles and the time period) to make it possible to determine whether there is valuable material in the mined material. Thus, the alternating magnetic field allows an increase in selectivity of heating of materials in particles of mined material based solely on properties such as the electrical conductivity and skin depth of valuable materials such as valuable minerals in the particles. The eddy currents that are induced by the alternating magnetic field are directly related to the electrical conductivity of the materials in the particles and therefore only electrical conductive materials, such as chalcopyrite, in the particles are heated and non-electrical conductive or lower electrical conductive materials such as clay and quartz in the particles are not heated at all or at least not to the same extent. There are two mechanisms here. First of all it is necessary that the valuable material be conductive in order to be associated with a substantial current. Second, it is important that the valuable material not be an extremely good conductor as the material will not generate sufficient ohmic heat. Also the smaller the size of the mined material the better will be the volumetric heating. If the mined material is magnetic e.g. ferromagnetic, such as magnetite, the particles are heated strongly with power loss directly proportional to the magnetic permeability. The magnitude of the eddy currents induced is directly proportional to the magnetic field intensity, magnetic field frequency and also electrical conductivity.

The benefits of indirect heating are that the energy is only generated in materials in particles of mined material that are electrically conductive (which changes with frequency) e.g. chalcopyrite has a electrical conductivity of 20-1000 S/m and quartz has a conductivity of 10e⁻¹⁴ S/m demonstrating the orders of magnitude differences between these two materials, one valuable and the other less valuable, often found together in copper-containing mined material which can be exploited to separate particles containing different amounts of these materials. In other words, the present invention makes it possible to discriminate between specific metal sulphide minerals and selectively identify particles containing specific minerals. As noted above, the present invention is not confined to copper-containing mined material and is applicable to a wide range of materials where differences in electrical conductivity of valuable and non-valuable components of the materials make it possible to discriminate between these components.

As electrical conductivity and therefore skin depth (or the depth to which currents are induced in particles) varies with magnetic field frequency, an optimum frequency can be determined for each valuable mineral or other valuable constituent material in a mined material in order to make it possible to allow mined material to be heated selectively compared to non-valuable material in mined material. In materials that are insulators, eddy currents are not induced. In materials that are highly conductive, eddy currents are induced but there is insufficient electrical resistance in the materials to produce heat in accordance with Joules First Law. Therefore, it is important to select the magnetic field frequency to optimise heating of valuable materials in mined material. The selection may include operating at multiple magnetic field frequencies.

Accordingly, fragments heated through the ohmic heating will be heated to different extents based on the quantity of electrically conductive materials, the conductivity of the materials and the depth in the fragment of the electrically conductive materials. The thermal analysis and subsequent sorting, therefore, is able to identify and separate fragments, based on the differences in temperature, for downstream processing from the remainder of the fragments.

The method may include selecting the alternating magnetic field to induce currents in any valuable material in the mined material to cause heating of valuable material and exposing the mined material to the selected alternating magnetic field and heating any valuable material.

The method may further comprise selecting the frequency of the alternating magnetic field to facilitate heating of valuable materials in the mined material when compared to non-valuable materials in the mined material.

The step of physically separating fragments according to the sorting criteria may comprise separating one category of fragments in one sorting stage, sending the remaining fragments to at least one further sorting stage for separating one or more further categories of fragments.

Determining the temperature of each fragment may comprise determining the temperature of part of the fragment.

Step (b) may further include determining a rate of temperature rise of each fragment and the thermal analysis may involve an assessment of the rate compared to or in conjunction with the fragment temperature.

Another aspect of the present invention provides a method of recovering valuable material from mined material, the method comprising (a) sorting mined material on the basis of susceptibility to electromagnetic radiation as described above to obtain mined material containing the valuable material and barren mined material and (b) subjecting the mined material containing the valuable material to downstream processing to recover the valuable material.

In another aspect, the invention provides an apparatus for sorting fragments of mined material that includes valuable and non-valuable materials, with some fragments containing more valuable material or more non-valuable than other fragments, the apparatus comprising:
(a) a treatment station for heating fragments of mined material by heating selected materials within the fragments;
(b) a thermal analysis assembly for analysing the thermal response of fragments; and
(c) a sorting assembly configured to physically sort fragments of mined material on the basis of the thermal analysis to separate fragments having a temperature within a temperature band defined by a range between an upper temperature limit and a lower temperature limit from fragments that are outside the temperature band; and
   wherein the upper and lower temperature limits are selected to identify fragments as containing an amount of valuable material that is economically viable to extract based on the fragment temperature caused by the heating.

The upper temperature limit may be selected to discriminate between fragments that are heated by valuable materials and fragments that are heated by non-valuable materials that are more susceptible to heating than the valuable materials.

The thermal analysis assembly may include a processor that receives the thermal analysis from the thermal analysis assembly and that applies the upper and lower temperature limits to identify the barren fragments and the fragments containing valuable material.

The sorting assembly may comprise a separator that directs the barren fragments into a stream and directs the fragments containing valuable material into another stream.

The processor may be configured with the temperature band that is selected to identify fragments as containing valuable material based on the fragment having a temperature or a temperature rise, caused by exposure to electromagnetic radiation, in the range and to identify fragments as barren fragments based on a temperature or a temperature rise outside the range.

The processor and the separator may be configured with the temperature band to direct the fragments containing an amount of valuable material containing an amount of valuable material that is economically viable to extract into two or more separate streams.

The processor and the separator may be configured with the temperature band to direct the fragments containing valuable material into two or more separate streams depending on suitability for a designated downstream processing option.

The suitability may be determined by the content of valuable material within a fragment.

The treatment station may be adapted to generate electromagnetic radiation and to expose the fragments to the electromagnetic radiation.

The treatment station may be adapted to generate an alternating magnetic field and to expose the fragments to the alternating magnetic field.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1 is a flow chart of an embodiment of a method of sorting ore according to an aspect of the present invention;

FIG. 2 is a diagram of an embodiment of an apparatus for sorting mined material according to the present invention;

FIG. 3 is a diagram of the embodiment in FIG. 2 overlaid with a thermal analysis and sorting flowchart; and

FIG. 4 is a representation of temperature band sorting in accordance with an embodiment of a method of the present invention.

### DESCRIPTION OF EMBODIMENT

The embodiment is described in the context of a method of recovering a valuable metal in the form of copper from low grade copper-containing ores in which the copper is present in copper-containing minerals such as chalcopyrite and the ores also contain non-valuable gangue. The objective of the method in the embodiment is to identify fragments of mined material, in the form of particles, containing amounts of copper-containing minerals above a certain grade and to sort these particles from the other particles and to process the copper-containing particles using the most effective and viable option to recover copper from the particles.

It is noted that, whilst the following description does not focus on the downstream processing options, these options are any suitable options ranging from smelting to leaching.

It is also noted that the present invention is not confined to copper-containing ores and to copper as the valuable material to be recovered. In general terms, the present invention provides a method of sorting any mined materials which exhibit different heating responses when exposed to electromagnetic radiation. The mined materials may be metalliferous materials and non-metalliferous materials. Iron-containing and copper-containing ores are examples of metalliferous materials. Coal is an example of a non-metalliferous material.

It is also noted that the present invention is not confined to using a temperature threshold (as an indication of grade) as the sole basis for sorting the particles and the invention extends to considering other properties that are indicators of the suitability of particles for downstream recovery processes.

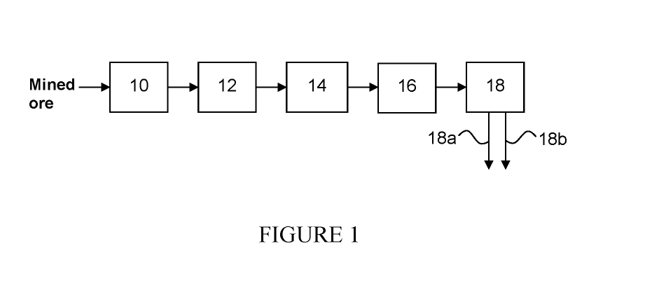

Referring firstly to FIG. 1, a process for processing mined ore is shown as a flowchart. Specifically, large rocks and boulders of ore are reduced in size in a primary crusher 10 and then sent to a comminution station 12 to reduce the ore further to particles having a size less than 100 mm. The ore particles are then sorted to obtain a stream of ore particles that contains a high content of a valuable material and a stream of ore particles that contains a low content of a valuable material.

Generally speaking, a bulk quantity of ore particles is exposed 14 to an excitation radiation that is selected to heat the valuable mineral. Ore particles that have a high valuable-material content are heated. For convenience, these particles are termed “hot” particles although their temperature may be only slightly higher than ambient temperature. Some ore particles with a low content of the valuable-material are not heated to the same extent and, for convenience, are termed “cold” particles. The result is that a thermal differential is produced between high and low valuable-material content ore particles. This thermal difference enables the ore particles to be sorted.

Some ore particles, however, have a low valuable material content, but contain materials, such as clay, that are susceptible to electromagnetic radiation. These materials have a strong effect in heating the particles because the materials are relatively abundant in the particles and/or they contain minerals with bound water that has a high susceptibility to some types of electromagnetic radiation, including microwave energy. The abundance of the material means that it may form part of the surface of particles. Accordingly, thermal analysis of the particles will register a higher heat signature than particles where the heat signature is a product of heat diffusing through a particle from a small amount of material that is excited by the electromagnetic radiation. For convenience, these particles with a low valuable material content and with materials susceptible to electromagnetic radiation will be referred to as “hot” barren particles. The high heat signature of the “hot” barren particles enables them to be distinguished from “hot” and “cold” particles and, therefore, enables them to be sorted from other particles.

In one form, the excitation radiation is microwave energy. However, it will be appreciated that, amongst other factors, the excitation radiation is selected on the basis of the ore being processed and on the basis of establishing a thermal differential sufficient for sorting. In regard to the latter, the thermal differential is sufficient for a thermal detector to discriminate between “hot”, “cold” and “hot” barren particles. Accordingly, the excitation radiation may be x-radiation or other suitable electromagnetic radiation.

The microwave radiation is applied at a level to create a power density within the particles that is below the level that is required to induce micro-fractures in the particles. In any event, the microwave frequency and microwave intensity and the particle exposure time and the other operating parameters of the exposure 14 are selected having regard to the information that is required. The required information is information that is helpful in terms of classifying the particular mined material for sorting and/or downstream processing of the particles. In any given situation, there will be particular combinations of properties, such as grade, mineralogy, hardness, texture, structural integrity, and porosity, which will provide the necessary information to make an informed decision about the sorting and/or downstream processing of the particles, for example, the sorting criteria to suit a particular downstream processing option.

It will be appreciated, however, that the invention is not limited to applying electromagnetic radiation in a manner that avoids micro-fractures to particles.

The bulk quantity of ore particles is then subjected to a distributor apparatus, in the form of a distributor station 16, which spatially distributes the particles in preparation for sorting. The distributed particles then pass to a sorting apparatus 18 that identifies and separates “cold” particles from “hot” particles and from “hot” barren particles, thereby producing a “cold” stream 18a and a stream 18b of “hot” particles and “hot” barren particles. It will be appreciated, however, that the particles may be sorted into more than two streams depending on the suitability and availability of downstream processing operations to process particles of different ore grades.

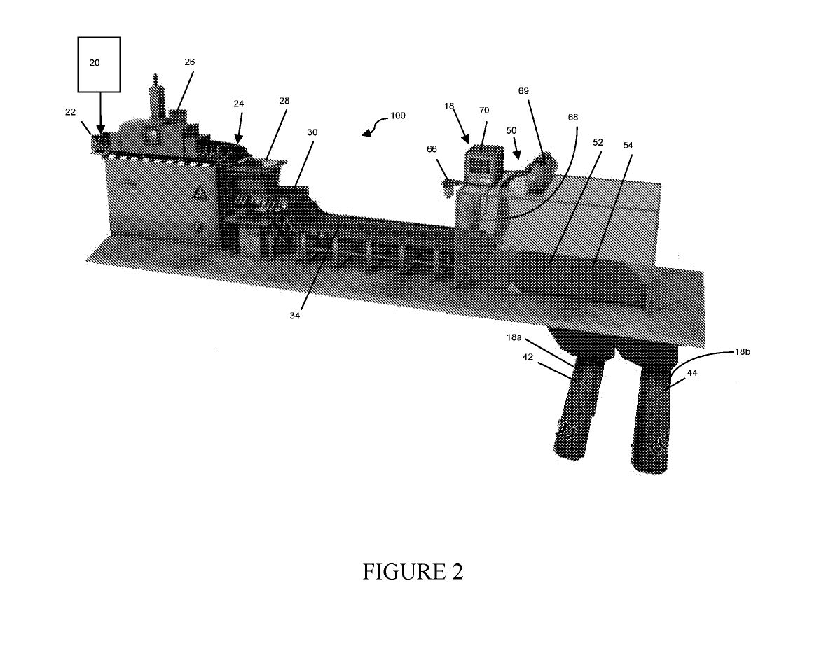

An example of a sorting apparatus is shown in FIG. 2. Specifically, a feed material in the form of ore particles that have been crushed by a primary crusher (not shown) to a particle size of 10-25 cm are supplied via a feed assembly 20 onto a conveyor belt 22 and the belt 22 transports the particles through an exposure 14 stage in the form of a microwave radiation treatment assembly 24 that includes an exposure chamber 26.

The particles on the belt 22 are exposed to microwave radiation on a particle by particle basis as they move through the exposure chamber 26 of the microwave radiation treatment assembly 24. The microwave radiation may be either in the form of continuous or pulsed radiation.

The particles leave the exposure chamber 26 and are delivered by the conveyor 22 into a chute 28 which directs the particles onto a dispersion plate 30. Particles are spread relatively evenly by action of the dispersion plate 30. The dispersion plate is operated as a vibrating plate that causes the particles to spread apart from each other and that causes the particles to travel from an outlet of the chute to a drop-off edge 32 of the plate 30 opposite the outlet.

The evenly dispersed particles fall from the dispersion plate 30 onto a further conveyor 34 which delivers the particles to a thermal analysis stage 18 of the sorting apparatus 100.

While travelling on the conveyor 34, the particles are subjected to thermal analysis. In this embodiment, radiation from the particles is detected by high resolution, high speed infrared imagers 66 which capture thermal images of the particles. While one thermal imager is sufficient, two or more thermal imagers may be used for full coverage of the particle surface.

In addition, one or more visible light cameras (not shown) capture visible light images of the particles to allow determination of particle size. From the number of detected hot spots (pixels), temperature, pattern of their distribution and their cumulative area, relative to the size of the particle, an estimation of the grade of observed rock particles can be made. This estimation may be supported and/or more mineral content may be quantified by comparison of the data with previously established relationships between microwave induced thermal properties of specifically graded and sized rock particles.

It is noted that there may be a range of other sensors (not shown) positioned within and/or downstream of the microwave exposure chamber depending on the required information to classify the particles for sorting and/or downstream processing options. These sensors may include any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale.

Images collected by the thermal imagers 66 and the visible light sensors (and any other sensors) are processed, for example, using a computer 70 equipped with image processing software. The software is designed to process the sensed data to classify the particles for sorting and/or downstream processing options. In any given situation, the software may be designed to weight different data depending on the relative importance of the properties associated with the data.

The sorting apparatus 18 comprises a thermal detector 66, in the form of an infrared camera. The detector 66 is calibrated to determine whether a given particle is “hot” or “cold”. The temperature of a particle is related to the amount of copper minerals in the particle. Hence, particles that have a given size range and are heated under given conditions will have a temperature increase to a temperature above a lower threshold temperature “x” degrees if the particles contain at least “y” wt. % copper. Particles that are heated to a temperature above an upper threshold temperature “z” degrees are designated as “hot” barren particles. The upper threshold temperature can be selected initially based on economic factors and adjusted as those factors change.

The thermal analysis 18 determines the temperature rise of particles as a result of exposure 14 to microwave energy in the microwave treatment assembly 24.

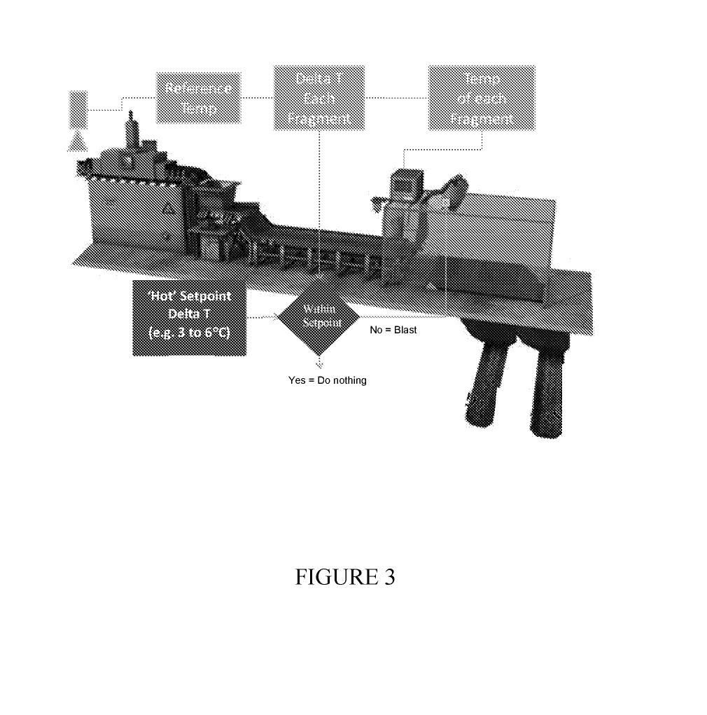

Specifically, a thermal imaging camera 20 is positioned to scan particles entering the microwave treatment assembly 24. The camera 20 determines the temperature of particles and this temperature is taken as a reference temperature. This reference temperature is compared with the particle temperature obtained by the first thermal analysis 18 to determine the temperature rise (“Delta T” in FIG. 3) of each particle as a result of exposure to the microwave energy. Sorting criteria is then applied to the temperature rise of each particle to determine how the particles are to be sorted. The sorting criteria in this embodiment comprises a temperature rise within a temperature band which is selected to be representative of a threshold copper content in particles that are economical to process in downstream operations to recover copper metal. The set temperature rise is 3 to 6° C. so that a particle having a temperature rise less than 3° C. is classified as a “cold” particle and therefore is designated for rejection by a separator assembly 50. Particles having a temperature rise greater than 6° C. are classified as “hot” barren particles and therefore are designated for rejection by the separator assembly 50. A particle having a temperature rise between 3° C. and 6° C. is classified as a “hot” particle and therefore is designated for downstream processing to recover copper. It will be appreciated, however, that the temperature band may be adjusted depending on process economics.

Although the reference temperature according to this embodiment is determined by the camera 20, the reference temperature may be determined in other ways. For example the particles may be pre-treated so that the particles achieve a pre-determined reference temperature. Accordingly, the reference temperature may be recorded in the computer 70 as a fixed temperature, rather than being actively monitored.

Once the thermal and visual light analysis is completed by the computer 70 and each particle is classified, the particles are separated by the separator assembly 50 that includes an array 68 of air ejectors spaced at intervals over a distance that is approximately the same as the width of the belt 34. The array 68 is fed with compressed air from a compressed air source, such as cylinder 69. The particles are separated by being projected from the end of the conveyor 34 and being deflected selectively by compressed air jets (or other suitable fluid jets, such as water jets) as the particles move in a free-fall trajectory from the conveyor 34. The particles are thereby sorted into two streams that are collected in the chutes 52, 54. The thermal analysis identifies the position of each of the particles on the conveyor 34 and the air jets are activated a pre-set time after a particle is analysed as a particle to be deflected.

In the present instance, the primary classification criterion is the temperature rise of particles as an indication of the grade of the copper in the particle. Particles outside a threshold grade (i.e. having a temperature rise outside the temperature rise) are separated into one collection chute 52 as stream 18a and particles above the threshold grade (i.e. having a temperature rise within the temperature rise band) are separated into the other chute 54 as stream 18b. The valuable particles sent to chute 54 are then processed to recover copper from the particles. For example, the valuable particles in the chute 54 are transferred for downstream processing including milling and flotation to form a concentrate and then processing the concentrate to recover copper.

In an alternative embodiment, the separator assembly 50 may be calibrated to deflect “hot” particles and to allow “cold” particles to continue on their original trajectory.

The particles in stream 18a may become a by-product waste stream and are disposed of in a suitable manner. However, this may not always be the case. The particles have lower concentrations of copper minerals that may be sufficiently valuable for recovery by alternative methods. In that event, the “cold” particles may be transferred to a suitable recovery process, such as leaching.

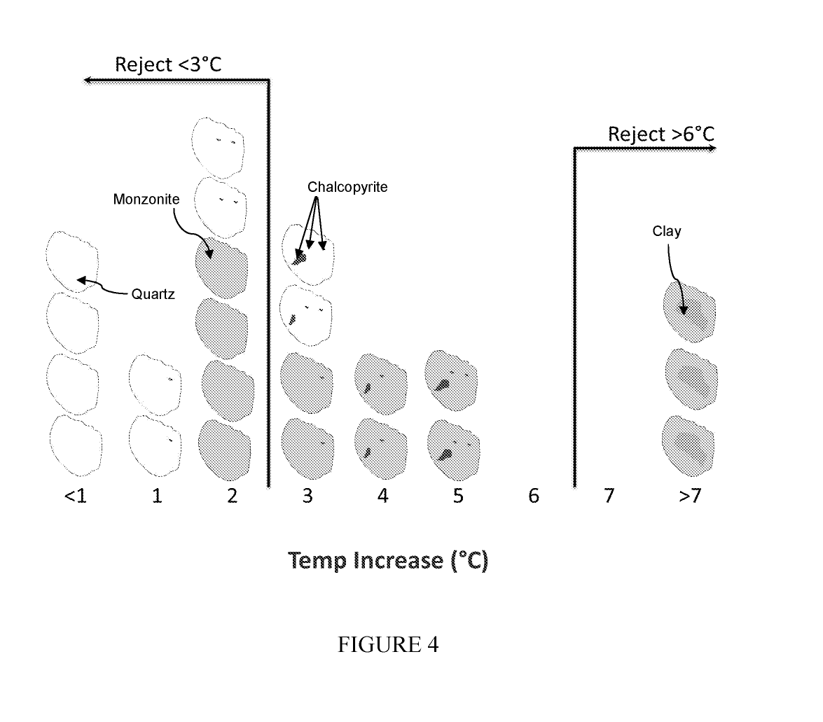

The temperature band applied by the sorting apparatus 18 is selected to separate particles containing valuable material from barren particles. A diagrammatic representation of an example of sorting criteria applied to copper-bearing ore is shown in FIG. 4. The temperature band is selected to separate particles having a temperature rise in a set range (i.e. particles having a temperature within a temperature band) from other particles. In this case the set range is a temperature rise, caused by exposure to the electromagnetic radiation, of 3 to 6° C. from pre-exposure particle temperatures.

The upper and lower thresholds in the sorting criteria are necessary to separate as much barren mined material from the valuable material, in this case chalcopyrite.

It will be appreciated from FIG. 4 that the primary material comprising particles will affect the temperature rise for the particles. Specifically, “cold” quartz particles generally record a lower temperature rise than “cold” monzonite particles when both are subjected to the same microwave energy. The effect is that monzonite particles containing very little chalcopyrite can be included amongst the particles that record a temperature rise in the range of 3 to 6° C. Quartz particles having a higher valuable material content will record a similar temperature rise. It is important, therefore, to select upper and lower thresholds that produce an output stream of mined material that is economical to process in downstream recovery operations.

Whilst a number of specific apparatus and method embodiments have been described, it should be appreciated that the apparatus and method may be embodied in many other forms.

By way of example, whilst the embodiment includes separating particles within the temperature range from particles outside the temperature range in a single separation step, the present invention is not so limited and extends to sorting methods and apparatus where multiple separation steps are employed. For example, a first separation step may separate particles having a temperature above a lower limit from particles that are colder than the lower limit. A second, downstream separation step may be applied to separate particles having temperature below an upper limit from particles that are hotter than the upper limit. Furthermore, the sorting criteria may be selected to separate particles in the temperature band into separate streams based on valuable material content. Accordingly, four or more streams of particles may be produced by the sorting method and apparatus of the present invention.

Alternatively, the thermal analysis 18 and the separator assembly 50 may be configured with sorting criteria on the basis of multiple temperature bands. The multiple temperature bands may be separate, discrete bands. The multiple temperature bands may overlap such that one temperature band is a subset of a broader temperature band.

By way of another example, the thermal analysis stage may involve determining the temperature rise of each fragment, together with the temperature of each fragment. The analysis, in this circumstance, involves considering the rate of temperature rise alongside the fragment temperature to assess whether the fragment includes super-heater materials and, therefore, is a barren fragment. Whilst a specific apparatus and method embodiment have been described, it should be appreciated that the apparatus and method may be embodied in many other forms.

For example, it should be appreciated that heating of the fragments of mined material may be achieved through ohmic heating Disclosure above and as described in Australian provisional application 2013900972, namely by exposing fragments to an alternating magnetic field to induce eddy currents in electrically conductive materials such that ohmic resistance to the eddy currents causes heating of the fragments. In this regard, the microwave treatment assembly 24 in the above embodiment may be replaced by a magnetic field generator assembly and this assembly may be operated to heat fragments of ore by exposing the fragments to a selected alternating magnetic field.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A method of sorting fragments of mined material that includes valuable and non-valuable materials, with some fragments containing more valuable material or more non-valuable material than other fragments, the method comprising:
(a) heating the fragments by heating selected materials within the fragments;
(b) thermally analysing fragments of the mined material to determine the temperature of each fragment; and
(c) sorting fragments on the basis of the thermal analysis to separate fragments having a temperature within a temperature band defined by a range between an upper temperature limit and a lower temperature limit from fragments having a temperature outside the temperature band; and
wherein the upper and lower temperature limits are selected to identify fragments as containing an amount of valuable material that is economically viable to extract based on the fragment temperature.

2. The method defined in claim 1, wherein the upper temperature limit is selected to discriminate between fragments that are heated by valuable materials and fragments that are heated by non-valuable materials that are more susceptible to heating than the valuable materials.

3. The method defined in claim 1, wherein step (c) comprises physically separating the mined material into a stream containing fragments within the range between the upper and lower temperature limits and another stream of fragments that is outside the range.

4. The method defined in claim 3, wherein physically separating fragments according to the temperature band comprises separating fragments having a temperature rise below the lower temperature limit in one sorting stage and sending the remaining fragments to at least one further sorting stage for separating fragments having a temperature rise above the upper temperature limit.

5. The method defined in claim 4, wherein the temperature band is 3 to 6° C. for fragments containing chalcopyrite as the valuable material in copper ore.

6. The method as defined in claim 1, wherein the step of sorting the fragments further comprises sorting the fragments containing valuable material into two or more streams.

7. The method defined in claim 6, wherein the temperature band is selected to sort the fragments containing valuable material into the two or more streams depending on suitability for a designated downstream processing option.

8. (canceled)

9. The method defined in claim 1, wherein step (a) comprises exposing the fragments to electromagnetic radiation and involves selecting the type and energy of the electromagnetic radiation and the length of exposure on the basis of facilitating a differential thermal response in the fragments of mined material to enable different temperatures of the fragments to be used as a basis for the thermal analysis.

10. (canceled)

11. The method defined in claim 9, wherein step (a) comprises exposing the fragments to pulsed or continuous electromagnetic radiation.

12. The method defined in claim 1, wherein the method further comprises allowing sufficient time for the heat generated in the fragments by exposure to the electromagnetic radiation to be transferred through the fragments so that the temperature on the surface of each fragment is a measure of the mass average temperature through the fragment.

13. The method defined in claim 1, wherein step (b) further includes determining a rate of temperature rise of each fragment and the thermal analysis involves an assessment of the rate compared to or in conjunction with the fragment temperature.

14. The method defined in claim 1, wherein step (a) comprises exposing the fragments to an alternating magnetic field and involves selecting the alternating magnetic field to induce currents in any valuable material in the mined material to cause heating of valuable material and exposing the mined material to the selected alternating magnetic field and heating any valuable material.

15. The method defined in claim 14 includes selecting the frequency of the alternating magnetic field to facilitate heating of valuable materials in the mined material when compared to non-valuable materials in the mined material.

16. The method defined in claim 1, wherein the mined material is a copper-containing ore and the valuable material is chalcopyrite and wherein step (a) comprises exposing the mined material to microwave energy.

17. (canceled)

18. An apparatus for sorting fragments of mined material that includes valuable and non-valuable materials, with some fragments containing more valuable material or more non-valuable material than other fragments, the apparatus comprising:
(a) a treatment station for heating fragments of mined material by heating selected materials within the fragments;
(b) a thermal analysis assembly for analysing the thermal response of fragments to the electromagnetic radiation; and
(c) a sorting assembly configured to physically sort fragments of mined material on the basis of the thermal analysis to separate fragments having a temperature within a temperature band defined by a range between an upper temperature limit and a lower temperature limit from fragments that are outside the temperature band; and
wherein the upper and lower temperature limits are selected to identify fragments as containing an amount of valuable material that is economically viable to extract based on the fragment temperature.

19. The method defined in claim 17, wherein the upper temperature limit is selected to discriminate between fragments that are heated by valuable materials and fragments that are heated by non-valuable materials that are more susceptible to heating than the valuable materials.

20. The apparatus defined in claim 17, wherein the thermal analysis assembly includes a processor that receives the thermal analysis from the thermal analysis assembly and that applies the upper and lower temperature limits to identify barren fragments and fragments containing valuable material.

21. The apparatus defined in claim 19, wherein the sorting assembly comprises a separator that directs the barren fragments into a stream and directs the fragments containing valuable material into another stream.

22. The apparatus defined in claim 20, wherein the processor and the separator are configured with the temperature band to direct the fragments containing an amount of valuable material that is economically viable to extract into two or more separate streams depending on suitability for a designated downstream processing option.

23. (canceled)

24. (canceled)

25. The apparatus defined in claim 17, wherein the treatment station is adapted to generate electromagnetic radiation and to expose the fragments to the electromagnetic radiation.

26. (canceled)

27. A method of recovering valuable material from mined material, wherein the method comprises (a) sorting mined material on the basis of susceptibility to electromagnetic radiation as defined in claim 1 to obtain mined material containing the valuable material and barren mined material and (b) subjecting the mined material containing the valuable material to downstream processing to recover the valuable material.
